(19) United States
(12) Patent Application Publication
(10) Pub. No.: US 2024/0209661 A1
(43) Pub. Date: Jun. 27, 2024

(54) MOTOR-VEHICLE LOCK, IN PARTICULAR ELECTRIC LOCK

(71) Applicant: KIEKERT AG, Heiligenhaus (DE)

(72) Inventor: Peter SZEGENY, Engelskirchen (DE)

(73) Assignee: KIEKERT AG, Heiligenhaus (DE)

(21) Appl. No.: 18/556,920

(22) PCT Filed: May 5, 2022
(86) PCT No.: PCT/DE2022/100341

§ 371 Date: Oct. 24, 2023

(30) Foreign Application Priority Data
May 6, 2021 (DE) 10 2021 111 853.0

(51) Int. Cl. E05B 81/82; E05B 81/04; E05B 81/14; E05B 81/64

(52) U.S. Cl. CPC E05B 81/82; E05B 81/04; E05B 81/14; E05B 81/64

(57) ABSTRACT

A motor-vehicle lock, in particular electric lock, which is equipped with a locking mechanism made up substantially of a rotary latch and a pawl. The lock further comprises an electromotive opening drive for the locking mechanism and an energy storage unit for emergency supply of the opening drive with current and thus for emergency opening of the locking mechanism in the emergency operating mode. According to the invention, the locking mechanism is maintained in its “open” state in the emergency operating mode or following an opening operation, by means of the opening drive.

The invention relates to a motor-vehicle lock, in particular electric lock, comprising a locking mechanism made up substantially of a rotary latch and a pawl, further comprising an electromotive opening drive for the locking mechanism, and comprising an energy storage unit for emergency supply of the opening drive with current and thus for emergency opening of the locking mechanism in the emergency operating mode.

Motor-vehicle locks, and in particular electric locks, are characterized in that they provide a special comfort for the user when opening an associated motor-vehicle door. The motor-vehicle door may generally be a motor-vehicle side door, but also a motor-vehicle tailgate, a motor-vehicle fuel filler flap, a motor-vehicle charging flap, etc. The opening operation is generally initiated by a remote control or by the operator actuating a sensor or switch. This can be present, for example, on or in an outer door handle.

In a motor-vehicle lock, and in particular an electric lock, as has become known in this context by DE 10 2019 128 296 A1, a so-called mechanical redundancy is additionally realized in addition to the electromotive opening drive. By means of this mechanical redundancy, a mechanical coupling for manually lifting of the pawl is possible in order, for example, in the event of a failure of an electrical power supply, to be able to emergency open the associated motor-vehicle door in emergency operating mode. The mechanical redundancy is realized and implemented at this point in such a way that a coupling element is provided, wherein the actuator realized at this point can be connected to said coupling element by means of a Bowden cable. An internal actuation and/or external actuation can then be realized, in particular during emergency operating mode, via the Bowden cable.

In this context, the generic prior art according to DE 10 2019 126570 A1 provides for a drive assembly for a motor-vehicle lock which is equipped with a main drive operating on an actuating lever unit. In addition, an auxiliary drive is realized for emergency unlocking or emergency opening of a locking mechanism. The auxiliary drive is designed as a component of an auxiliary module which is mechanically connected to the motor-vehicle door lock and is functionally independent. The auxiliary module may in turn be equipped with an energy source or auxiliary energy source, respectively. This is an accumulator, one or more capacitors, or combinations thereof.

The entire prior art has in principle proven to be successful when it comes to realizing and implementing an emergency operating mode of the motor-vehicle lock for emergency opening of the locking mechanism. For this purpose, however, the prior art falls back, on the one hand, on mechanical redundancy within the scope of DE 10 2019 128 296 A1 and, on the other hand, on an auxiliary drive according to the generic DE 10 2019 126 570 A1. In both cases, this requires additional devices, mechanical connections, etc. As a result, the structure is complex and sometimes expansive. The invention as a whole seeks to remedy this.

The invention is based on the technical problem of further developing such a motor-vehicle lock, and in particular an electric lock, such that the design effort is reduced and a particularly compact embodiment is observed.

In order to solve this technical problem, a generic motor-vehicle lock, and in particular an electric lock, within the scope of the invention is characterized in that the locking mechanism is maintained in its “open” state in the emergency operating mode as well as in an or following an opening operation or in an or following an emergency opening, by means of the opening drive.

The invention thus in principle proceeds such that the emergency operating mode corresponds to the locking mechanism assuming its open state in the event of an emergency opening or following an emergency opening and maintaining this open state. For this purpose, in emergency operating mode, the energy storage unit generally ensures emergency supply of the opening drive with current. This is because in emergency operating mode, a main energy source used in normal operation to power the electromotive opening drive, in the form of, for example, an accumulator in the motor vehicle, usually fails or does not provide sufficient power to be able to move the electromotive opening drive. In emergency operating mode, this is ensured by the energy storage unit, which is designed to be independent of the main energy source.

Here, the procedure is usually such that the locking mechanism is maintained in the “open” state in an or following a first emergency opening or a first opening operation, respectively. That is, as soon as the motor vehicle or an associated control device or control unit switches to emergency operating mode, a first opening operation and thus the first emergency opening leads to the opening drive being emergency supplied with current by means of the energy storage unit and the locking mechanism thus being transferred to its “open” position. In this “open” state, the lock is now held (permanently).

In fact, the emergency operating mode can occur, for example, when a motor vehicle has been parked for a longer period of time and the voltage of the main power source on the motor vehicle side has dropped to such an extent that it is not (or no longer) able to energize the electromotive opening drive for the locking mechanism. In such a case, the control unit already mentioned is used to switch over to emergency operating mode, for example, when the operating voltage provided by the main power source falls below a certain level. This means that the locking mechanism still maintains its closed state unchanged when the vehicle is parked. Only then when a user in emergency operating mode wants to open a motor-vehicle door associated with the motor-vehicle lock, for example, by actuating a sensor or a remote control, is the emergency opening initiated.

It is understood that in emergency operating mode, the sensor in question as well as an optimal transmitter/receiver unit are usually energized by means of the energy storage device or also additionally by the main energy source, in order to be able to detect the opening request of the operator in emergency operating mode at all. Either way, a first emergency opening or a first opening operation following the operator's opening request (after initiating emergency operating mode) now leads to the opening drive being emergency supplied with current by means of the energy storage unit. As a result, the opening drive is able to transfer the locking mechanism into its “open” state. This usually corresponds to the electromotive opening drive acting on the pawl and spacing it from the rotary latch. This means that the “open” state of the locking mechanism corresponds overall to the release of the rotary latch by means of the opening drive which, in emergency operating mode, is emergency supplied with current by the energy storage unit.

This spaced position of the pawl is now usually maintained until a mechanical and/or electronic reset occurs. The same applies to the “open” state of the locking mechanism. A mechanical reset means that the locking mechanism is transferred—back—to its closed state by mechanical means, or, in the specific example, the pawl is placed back on the rotary latch. As a result, the associated motor-vehicle door can subsequently be closed without any problem, because a locking bolt on the body side is then caught by the rotary latch and can be secured by means of the pawl, which is then free (from the opening drive), by latching on the rotary latch.

According to the invention, an electronic reset is usually used to cancel the “open” state of the locking mechanism again and specifically to act on the opening drive in the opposite direction so that it does not (or no longer) hold the pawl in its spaced position relative to the rotary latch. As a result, the pawl can then easily drop back into the rotary latch once it has caught the locking bolt. This means that the locking mechanism resumes its closed base position when reset.

The electronic reset is usually performed by interrogating at least one sensor. According to the invention, the actuation of two sensors corresponds particularly advantageously to the reset, in order to prevent incorrect operation or also manipulation. In this case, a predefined actuation sequence of the two sensors mentioned is usually used during reset.

In this manner, not only a proper emergency opening of the locking mechanism is provided. But this is also achieved without any mechanical redundancy or even without an auxiliary drive as according to the prior art. That is, in this way, the design effort according to the invention is significantly reduced compared to previous approaches. At the same time, dispensing with additional components ensures cost reduction and also weight optimization.

In addition, because the “open” state of the locking mechanism is maintained until reset, a user or operator cannot (or no longer) close the associated motor-vehicle door after the emergency opening or first emergency opening, respectively. This then leads to the user or operator being intuitively informed about the emergency operating mode immediately due to this phenomenon, and thus can initiate any countermeasures, such as commissioning a towing service. In addition, the operator or user is encouraged or forced to deal with this in order to be able to cancel the “open” state again and close the motor-vehicle door. This requires the operator or user to look up or having to look up, for example, in a manual, an app or elsewhere how to perform the electronic reset in the example case in order to be able to close the motor vehicle in question again. This leads to special attention and to the user having to take immediate countermeasures in order to get the motor vehicle moving again or to recharge the main energy source. All of this is achieved without additional information or warnings, simply due to the fact that the locking mechanism remains in the “open” state until the reset.

As a further advantage, this means that the energy storage unit only has to ensure at least the first and a second emergency opening. This is because at least the second emergency opening is regularly required in order to be able to open the motor vehicle in subsequent manner for repair purposes. As a result, a relatively small energy storage unit can be used, or respectively the motor-vehicle lock described also works according to the invention when the energy store itself (for example due to its age) should have a weak charging state. As a result, capacitors or so-called supercapacitors can advantageously be used as energy storage units, because usually only a limited number of actuations or emergency actuations (at least two emergency actuations) are required. Of course, the energy storage unit can also be designed as a battery or a combination of a capacitor or supercapacitor with a battery as a plurality of capacitors, a plurality of batteries, etc.

The sensor already mentioned for realizing the electronic reset is usually a door actuating switch. The actuation sequence usually realized in this context then corresponds to, for example, the fact that an inner door handle and an outer door handle have to be actuated simultaneously in order to realize the electronic reset and control the electromotive opening drive such that, in the example case, it no longer holds the pawl at a distance from the rotary latch in the “open” position of the locking mechanism. Of course, other actuation sequences or actuation patterns are also conceivable. For example, a specific sequence of actuations can be realized in the event that only one Sensor or door actuating switch is used. Either way, this is only resorted to in emergency operating mode, so that any incorrect operations in normal operating mode are excluded. In addition, even in emergency operating mode, the operator or user wishing to access the motor vehicle must authorize himself by, for example, engaging in a question/answer dialog with the motor vehicle or simply by the user having the (remote control) key that guarantees access.

As a result, a motor-vehicle lock, and in particular an electric lock, is made available, which, for the first time and in principle, opens up the possibility of basically being able to dispense with mechanical redundancy or also an auxiliary drive. All this is achieved without compromising safety in any way. Rather, the emergency operating mode is directly associated with the user or operator being intuitively informed of this. This applies both in the event that the associated motor vehicle changes from normal operating mode to emergency operating mode in a locked or closed state. Similarly, emergency opening can be carried out without any problems if the motor vehicle switches to emergency operating mode with the motor-vehicle door already open or even during the opening operation. In any case, the invention ensures that, by means of the electromotive opening drive, the locking mechanism is maintained in its “open” state in emergency operating mode by means of the opening drive until a reset occurs. These are the main advantages.

In the following, the invention will be explained in more detail with reference to a drawing which shows only one exemplary embodiment;

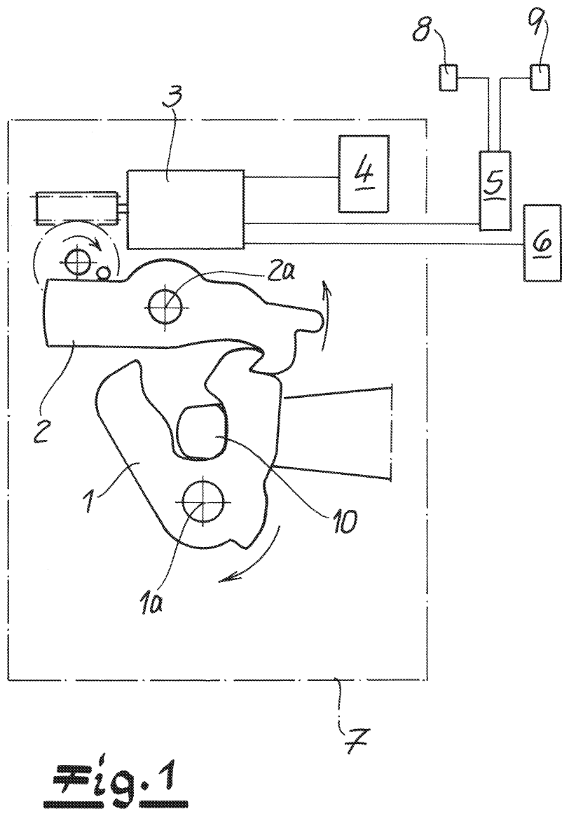

the single FIG. 1 shows a motor-vehicle lock according to the invention in its essential features for the invention.

FIG. 1 shows a motor-vehicle lock which, according to the exemplary embodiment, is a motor-vehicle side door lock. The motor vehicle door lock is designed as an electric lock, i.e., in normal operating mode it can only be opened electrically and not mechanically. For this purpose, the motor-vehicle lock shown has a locking mechanism 1, 2 made up substantially of a rotary latch 1 and a pawl 2. In addition, an electromotive opening drive 3 is provided for the locking mechanism 1, 2. Furthermore, an energy storage unit 4 for the emergency supply of the opening drive 3 with current and a control unit 5 can be seen, by means of which the electromotive opening drive 3 is controlled and which also monitors, for example, a main energy source 6 indicated in FIG. 1. The main energy source 6 is located inside a motor-vehicle body and is designed as an accumulator.

If the control unit 5, which is generally also provided on the motor-vehicle side, detects, for example, a drop in the electrical voltage provided by the main energy source 6, such that the electromotive opening drive 3 cannot (or can no longer) be powered by the main power source 6 in normal operating mode, the control unit 5 switches to emergency operating mode. In emergency operating mode, the opening drive 3 for emergency opening of the locking mechanism 1, 2 is emergency supplied with current by means of the energy storage unit 4.

The energy storage unit 4 can advantageously be one or more capacitors, so-called supercapacitors. These can typically be positioned in a space-saving manner inside a lock housing 7 which accommodates the locking mechanism 1, 2 and the electromotive opening drive 3 and is merely implied. If emergency operating mode now occurs, the energy storage unit 4 for emergency supplying of the opening drive 3 with current and thus for emergency opening of the locking mechanism 1, 2 in emergency operating mode ensures that the locking mechanism 1, 2 is maintained in its “open” state. This applies at least subsequently to an opening operation initiated by an operator.

In this opening operation, the procedure is usually such that the operator acts on a door actuating switch 8, 9. According to the exemplary embodiment, two door actuating switches 8, 9 are realized, namely an inner door actuating switch 8 and an outer door actuating switch 9. The opening operation is regularly initiated such that the operator acts on the outer door actuating switch 9. This applies in both normal operating mode and emergency operating mode.

The actuation of the outer door actuating switch 9 is detected by means of the control unit 5 and leads to the control unit 5 outputting a command to the electromotive opening drive 3 so that it opens the locking mechanism 1, 2. For this purpose, in the example shown, the opening drive 3, via an output-side worm, which is acted on in the clockwise direction, with actuating pin, acts on the pawl 2 pivotable about an axis 2a at its end remote from the rotary latch, so that the pawl 2, starting from the representation according to FIG. 1, is pivoted counterclockwise and is thereby spaced from the rotary latch 1. At the same time, the operation indicated by an arrow in FIG. 1 for lifting the pawl 2 by means of the opening drive 3 ensures that the rotary latch 1 is released. A clockwise movement of the rotary latch 1 about its axis 1a corresponds to this, so that a locking bolt 10 previously caught by means of the locking mechanism 1, 2 is released and the associated motor-vehicle door can be opened.

In emergency operating mode and subsequent to the described opening operation, the opening drive 3, which is supplied with current by means of the energy storage unit 4, now ensures that the locking mechanism 1, 2 not only assumes its “open” state, but is maintained “open” in this state by means of the opening drive 3, namely until a reset occurs. This is ensured by the control unit 5, which detects the emergency operating mode and powers the opening drive 3 accordingly. According to the exemplary embodiment, an electronic reset is realized. During this reset, the locking mechanism 1, 2 resumes its closed starting position. For this purpose, the opening drive 3, by means of the control unit 5 and with supply from the energy storage unit 4, is supplied with current such that the pawl 2 is no longer maintained at a spaced position from the rotary latch 1. Rather, the opening drive 3 releases the pawl 2 so that it can pivot, for example, in a spring-assisted manner into its position shown in FIG. 1. As soon as the locking bolt 10 moves into the open rotary latch 1 in this position of the pawl 2 in contact with the rotary latch 1 and pivots it counterclockwise during a closing process, the pawl 2 can subsequently drop back into its latching position, as shown in FIG. 1.

According to the invention, the electronic reset and the release of the pawl 2 are initiated by the interrogation of at least one sensor 8, 9. The sensor 8, 9 is the two door actuating switches 8, 9.

That is, the actuation of these two sensors 8, 9 or the door actuating switches 8, 9, respectively, corresponds to the electronic reset. This is initiated when a predetermined actuation sequence of the two sensors 8, 9 or of the door actuating switches 8, 9, respectively, is observed.

According to the embodiment, this actuation sequence corresponds to the fact that both the inner door actuating switch 8 and the outer door actuating switch 9 are acted on simultaneously. As a result, the control unit 5 sends a signal to the electromotive opening drive 3, so that it releases the pawl 2 so that the pawl 2 can return from its raised position to the closed position according to the representation in FIG. 1 in a spring-assisted manner. The motor-vehicle door equipped with the shown motor-vehicle lock or motor-vehicle door lock can now be closed again.

In order to open the motor-vehicle door in question, the opening operation must again be initiated by the operator, so that the emergency opening described then occurs in emergency operating mode. Subsequently, a new electronic reset is required. That is, in emergency operating mode, each door opening requires a subsequent electronic reset. Thereby, the operator is made aware immediately to the emergency operating mode, because the user cannot close the motor-vehicle door in question with the associated motor-vehicle lock again until the described actuation sequence has been carried out.

Since an operator usually does not know this actuation sequence, and instead has to look it up first, for example, in a manual or an App, the user is therefore insistently informed of the emergency operation mode and is sensitized to it. At the same time, this operation is used as a starting signal for any repair measures. These are the main advantages.

### LIST OF REFERENCE NUMBERS

1 rotary latch
1a axis
1, 2 locking mechanism
2 pawl
2a axis
3 opening drive
4 energy storage unit
5 control unit
6 main energy source
7 lock housing
8 inner door actuating switch
8, 9 door actuating switch, sensor
9 outer door actuating switch
10 locking bolt

1. A motor-vehicle lock comprising:
a locking mechanism including a rotary latch and a pawl,
an electromotive opening drive for performing an opening operation of the locking mechanism, and
an energy storage unit for emergency supply of the opening drive with current for emergency opening of the locking mechanism in an emergency operating mode,
wherein the locking mechanism is maintained in an open state by the opening drive in the emergency operating mode and in an or following the opening operation.

2. The motor-vehicle lock according to claim 1, wherein the locking mechanism is maintained in the open state in the emergency operating mode in a or following a first opening operation after initiating the emergency operating mode.

3. The motor-vehicle lock according to claim 1, wherein the open state of the locking mechanism is maintained until a mechanical and/or electronic reset.

4. The motor-vehicle lock according to claim 3, wherein, during the reset, the locking mechanism resumes a closed starting position.

5. The motor-vehicle lock according to claim 3, further comprising at least one sensor, wherein the electronic reset is carried out by interrogating the at least one sensor.

6. The motor-vehicle lock according to claim 5, wherein the electronic reset includes actuation of two sensors.

7. The motor-vehicle lock according to claim 6, wherein the reset comprises a predetermined actuation sequence of the two sensors.

8. The motor-vehicle lock according to claim 5, wherein the at least one sensor includes a door actuating switch.

9. The motor-vehicle lock according to claim 1, wherein the opening drive implements the open state of the locking mechanism by acting on the pawl to space the pawl apart from the rotary latch to release the pawl from the rotary latch.

10. The motor-vehicle lock according to claim 1, wherein the energy storage unit is designed as a capacitor, a supercapacitor, a battery, or a combination thereof.

11. The motor-vehicle lock according to claim 2, wherein the energy storage unit supplies power for a second opening operation after initiating the emergency operating mode.

12. The motor-vehicle lock according to claim 6, wherein the two sensors include sensors for actuating an inner door handle and an outer door handle.

13. The motor-vehicle lock according to claim 1, further comprising a control unit that monitors power provided to the opening drive, and when the power supplied to the opening drive drops below a predetermined level, the control units switches operation to the emergency operating mode.

14. The motor-vehicle lock according to claim 13, wherein the control unit controls the opening drive to move the locking mechanism into the open state in the emergency operating mode and in or following the opening operation.

15. The motor-vehicle lock according to claim 13, further comprising at least one sensor, wherein the control unit carries out an electronic reset by interrogating the at least one sensor such that the locking mechanism resumes a closed starting position.
